(19) United States
(12) Patent Application Publication
(10) Pub. No.: US 2010/0102749 A1
(43) Pub. Date: Apr. 29, 2010

(54) CIRCUIT ARRANGEMENT AND METHOD FOR ADAPTING THE OUTPUT OF HIGH-PRESSURE DISCHARGE LAMPS

(75) Inventor: Ludger Wilken, Berlin (DE)

Correspondence Address: Viering, Jentschura & Partner - OSR, 3770 Highland Ave., Suite 203, Manhattan Beach, CA, 90266, US

(73) Assignee: OSRAM Gesellschaft mit beschraenkter Haftung, Muenchen (DE)

(21) Appl. No.: 12/528,830

(22) PCT Filed: Jan. 28, 2008
(86) PCT No.: PCT/EP2008/050959

§ 371 Date: Aug. 27, 2009

(30) Foreign Application Priority Data
Feb. 28, 2007 (DE) 10 2007 009 736.2

(51) Int. Cl. H05B 41/36

(52) U.S. Cl. 315/291

(57) ABSTRACT

A circuit arrangement for adapting the output of high pressure discharge lamps that is suitable for operating with an inductor is provided, wherein the circuit arrangement includes an electronic switch that is connected in parallel with the lamp, and this parallel circuit is arranged in series with the inductor, the circuit arrangement being arranged in the high pressure discharge lamp.

Circuit arrangement and method for adapting the output of high-pressure discharge lamps

### TECHNICAL FIELD

The invention relates to an efficient high pressure lamp with integrated electronics that, in conjunction with the same light flux, can replace a high pressure lamp of higher output and lower efficiency. This lamp is intended to be inserted without further adaptations directly into the existing burning position with the existing conventional ballast of the lower efficiency high pressure lamp. The invention is aimed in particular at the ability to use as efficient high pressure lamp a standard lamp whose light flux does not correspond to that of the lower efficiency lamp to be replaced. The invention preferably relates in this case to the replacement of high pressure mercury vapor lamps with high pressure sodium vapor lamps that have a high efficiency. However, the invention can, of course, also be attained with any other pairing of lamps that exhibit a corresponding difference in the efficiency.

### PRIOR ART

To date, special lamps having properties adapted to the lamps to be replaced have been produced for retrofit applications. For years there have been high pressure sodium vapor lamps with a so-called Penning mixture that are ignited by the line voltage present. These lamps are known from de Groot and van Vliet, The High-Pressure Sodium Lamp, Kluwer Technische Boeken B. V.—Deventer, 1986, Chapter 6, Page 175. By comparison with normal high pressure sodium vapor lamps, these high pressure sodium vapor lamps have a lower light yield. The plasma has a higher thermal conductivity because of the neon/argon mixture in these lamps, and this entails higher thermal arc losses, and thus a relatively poor efficiency. Again, this gas mixture lowers the normally substantially high starting voltage of the high pressure sodium vapor lamp to the level of the high pressure mercury vapor lamp, such that it just becomes possible to make a direct replacement at the ballast of the high pressure mercury vapor lamp.

Dimmer circuits according to the prior art normally use a circuit in which the switch is connected in series with the lamp. By way of example, such a circuit is known from the application note “Littelfuse, Phase Control Using Thyristors, Application Note AN1003, 2004”.

### OBJECT

It is an object of the invention to develop a high pressure discharge lamp with integrated electronics that uses a lamp burner with a high light yield. The adaptation of light flux and therefore output is to be achieved by a dimmer circuit and the high starting voltages by means of a starting device that is integrated in the lamp, preferably in the base region of the lamp, specifically such that the dimension of the lamp does not exceed than that of the lamp to be replaced.

### SUMMARY OF THE INVENTION

The invention is achieved by circuit arrangement as claimed in claim 1 and an operating method as claimed in claim 11.

The circuit arrangement constitutes a dimmer circuit that simultaneously also takes over the function of the starting unit. In this case, the switch of the dimmer circuit is not connected in series with the lamp, but in parallel. This has the decisive advantage of a lesser distortion of the input current.

### BRIEF DESCRIPTION OF THE DRAWING(S)

FIG. 1 is a schematic of a dimmer circuit with a switch connected in series.

FIG. 2 is a schematic of a dimmer circuit with a switch connected in parallel.

FIG. 3 shows the current and voltage profiles of a high pressure sodium vapor lamp at a high pressure mercury vapor lamp inductor.

FIG. 4 shows the current and voltage profiles of a high pressure sodium vapor lamp at a high pressure mercury vapor lamp inductor with a dimmer in a series connection.

FIG. 5 shows a circuit arrangement for a dimmer circuit with a semiconductor switch in series with the lamp.

FIG. 6 shows the current and voltage profiles of a high pressure sodium vapor lamp at a high pressure mercury vapor lamp inductor with a dimmer in a parallel circuit.

FIG. 7 shows an inventive circuit arrangement for a dimmer circuit with a semiconductor switch in parallel with the lamp.

### PREFERRED DESIGN OF THE INVENTION

A high pressure mercury vapor lamp with a lamp output P_{HQL} and the light flux Φ_{HQL} is to be replaced by a high pressure sodium vapor lamp (NAV lamp) whose lamp output P_{Dim} is set such that the same light flux is generated. The high pressure sodium vapor lamp to be used emits the light flux Φ_{NAV} given an output of P_{NAV}. If it is assumed that the light flux is proportional to the power consumed in the case of the NAV lamp, the output of the high pressure sodium vapor lamp with a dimmer circuit can be calculated by

$${P}_{Dim} = {P}_{NAV} \frac{{Φ}_{HQL}}{{Φ}_{NAV}} \qquad ( 1 )$$

A first example is given for the purpose of illustration: For example, a high pressure mercury vapor lamp with a lamp output of 125 W (P_{HQL}=125 W) and a light flux of Φ_{HQL}=6500 lm which therefore has a light yield of Φ_{HQL}/P_{HQL}=52 lm/W can be replaced by a high pressure sodium vapor lamp with a very much higher light yield of Φ_{NAV}/P_{NAV}=100 lm/W, attainment of the same light flux according to equation 1 requiring an output of 65 W in order to generate the same light flux as that of the 125 W high pressure mercury vapor lamp.

An inductor is connected in series with the lamp in order to limit the current. In the case of the high pressure mercury vapor lamp use is made of an inductor with an impedance of Z_{D} (high pressure mercury vapor lamp)=143 Ω. The lamp voltage is U_{L} (high pressure mercury vapor lamp)=125 V and the lamp current is I_{L} (high pressure mercury vapor lamp)=1.15 A. To operate, a high pressure sodium vapor lamp with a similar light flux requires an inductor with Z_{D} (high pressure sodium vapor lamp)=202 Ω,the result being a voltage of U_{L} (high pressure sodium vapor lamp)=86 V and a current of I_{L} (high pressure sodium vapor lamp)=0.88 A (table 2). Both the lamp voltage and the lamp current are much smaller in the case of the high pressure sodium vapor lamp than in the case of the high pressure mercury vapor lamp. The operation of a high pressure sodium vapor lamp with a high pressure mercury vapor lamp inductor requires an additional circuit that reduces the mean current of a half wave, the result being to set the gas temperature, and thus the conductivity of the arc, to a specific value. This can be an electronic circuit, for example a dimmer circuit.

### Design of the Circuit Arrangement

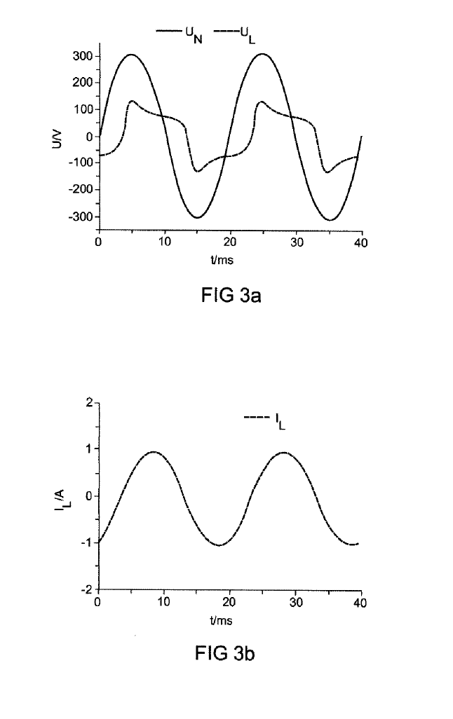

A further exemplary embodiment is used to explain the inventive circuit arrangement. The aim is to replace a 125 W high pressure mercury vapor lamp with a 65 W high pressure sodium vapor lamp having a high light yield. FIG. 3 shows the voltage and current profiles of this 65 W high pressure sodium vapor lamp with a 60 W high pressure sodium vapor lamp inductor. Since this 65 W high pressure sodium vapor lamp is to be operated with a 125 W high pressure mercury vapor lamp inductor, it is necessary to dim the high pressure sodium vapor lamp.

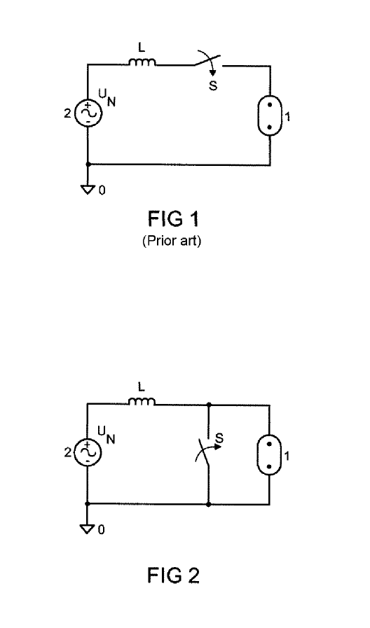

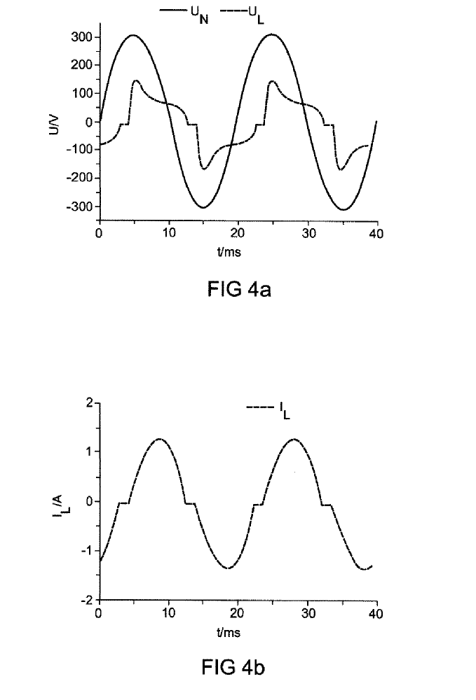

In the case of classic dimmer circuits for incandescent lamps, a switch in series with the lamp is switched on and off at line frequency (FIG. 1). The voltage, current and output averaged over a period are thereby reduced. FIG. 4 shows the voltage profile and current profile of a high pressure sodium vapor lamp dimmed with such a circuit. As a rule, a triac is used as electronic switch (S). The latter is of high resistance in the blocked state and of low resistance in the conductive state. A starting pulse applied to the control input switches the latter through and then switches it off again at a current zero. In the case of phase-gating control, this triac is switched on for a certain time after the voltage zero. To this end, the line voltage present charges a capacitor via a resistor. After the buildup of a certain voltage, the diac has a low resistance and allows a starting pulse to pass to the control input of the triac. The triac is switched through. The voltage present across the lamp rises until the lamp once again goes over into the conductive state and a current flows. This circuit has the property that the input current is strongly distorted, and so the harmonics of the current exhibit a large proportion by comparison with the fundamental wave.

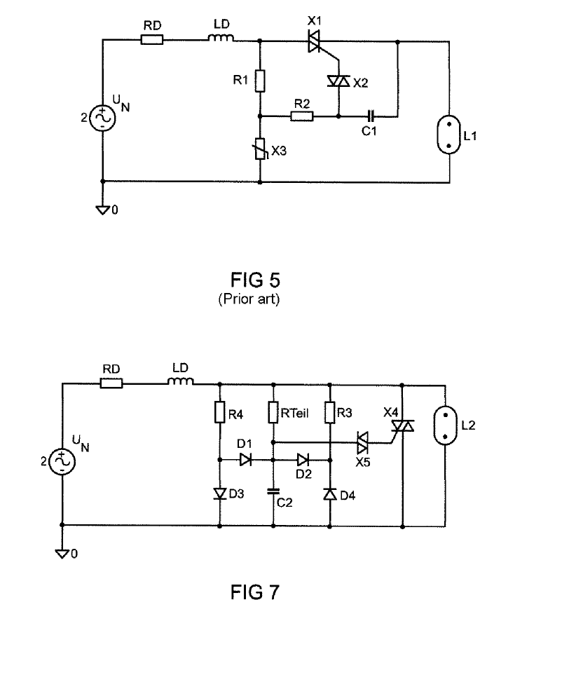

A circuit according to the known prior art is illustrated in FIG. 5 by way of example. In this circuit, V_{N} is the line voltage, and the series circuit of Rₚ and Lₚ is the simplified equivalent circuit diagram of the inductor. The triac X1 is started by the diac X2 following a certain time after the voltage zero, the circuit being closed and the lamp L1 being switched on as a consequence. The capacitor C1 is charged by the voltage divider composed of the resistor R1 and the varistor X3 and the series resistor R2 and the conductive channel in the lamp L1. As soon as the voltage present across the capacitor C1 is greater than the starting voltage of the diac X2 (30V), the latter passes the starting pulse to the triac X1, which closes the lamp circuit. The capacitor is charged by the diac X2 to a residual voltage (19V). After the switching through, the capacitor is charged by the resistor network. The triac X1 is closed at the current zero. The capacitor is recharged in the following half wave. The components in the drive circuit are selected so as to set the desired output. However, a problem occurs with the harmonics of the current in the case of this type of dimmer circuit.

Lines and generators are placed under load by the harmonics in the current. In the event of a high current proportion in the higher harmonics, the systems must be designed for relatively large outputs, something which causes higher costs. Consequently, many countries have limiting values that define the proportion of the nth to the 1st harmonic, the fundamental wave.

In the case of discharge lamps, the supply current of the lamp/ballast system will not permit it to overshoot the values of the IEC 1000-3-2 as given in table 1, for example. λ is the power factor:

$$λ = \frac{{P}_{s}}{{U}_{N} {I}_{N}} \qquad ( 2 )$$

Here, U_{N} and I_{N} are the root-mean-square values of the voltage and the current. P_{S} is the system power, which is calculated from the sum of the lamp power P_{L} and the power absorbed by the inductor. The proportion of the 3rd to the 1st harmonic is critical. Said proportion is not allowed to overshoot a value of 0.3 λ, see table 1.

TABLE 1
Limiting values of the ratios of the nth harmonic to
the 1st harmonic according to IEC 1000-3-2.

| | N | | | | |
|---|---|---|---|---|---|
| | 2 | 3 | 5 | 7 | 9 |
| Ratio | I₂/I₁ | I₃/I₁ | I₅/I₁ | I₇/I₁ | I₉/I₁ |
| Limiting | 2% | 0.3 λ | 10% | 7% | 5% |
| value | | | | | |

The first example will be briefly taken up again in order to illustrate the problem: A high pressure sodium vapor lamp that is being operated with the aid of a lamp dimmer with a series-connected switch element has a system power of P_{S=}65.6 W (P_{L})+11.1 W (P_{N}), is at a voltage of U_{N}=220 V and allows a current I_{N}=0.907 A to flow. In contrast to operation with the 125 W high pressure mercury vapor lamp, the system power is reduced from 125 W+15 W to 76.7 W in the case of operation with the phase gating controller in conjunction with the same light flux. This results in the following harmonics of the current: A value of: 0.3 λ=11.6% results from the calculation of the limiting value in accordance with the standard. The measured proportion of the 3rd to 1st harmonic of the current is: I3/I1=15.9%, which is essentially above the limiting value. Consequently, a dimmer circuit according to the prior art is not suitable for retrofit applications.

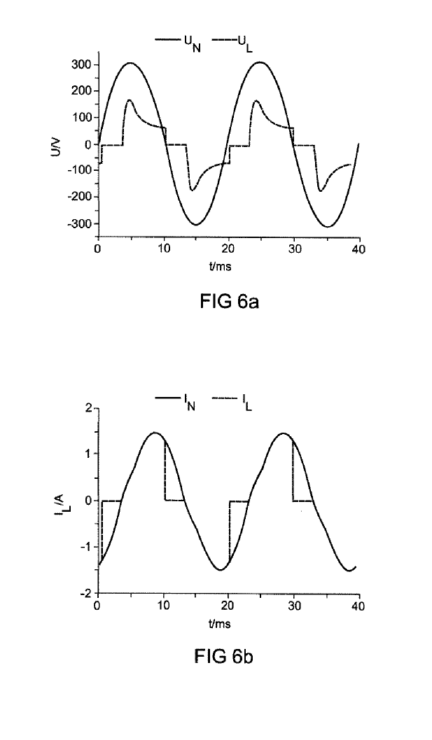

In the case of the inventive circuit, a switch is connected downstream of the inductor and in parallel with the lamp (FIG. 2). This switch short circuits the circuit periodically, the result being that the voltage at the lamp vanishes and the lamp is extinguished (FIG. 6). Since the impedance of the inductor is greater than the resistance of the lamp, the input current hardly changes upon closure of the short circuit switch, and so the input current is scarcely distorted and the proportion of the harmonic to the fundamental wave hardly increases. It may be pointed out that during the starting or extinguishing of the lamp the inductor generates high voltages that, in the event of the absence of a protective device, can destroy the electronic switch or fire it. The starting device and the inventive dimmer circuit must therefore be tuned to one another. Although any suitable starting device topology is conceivable in principle, preference is given, however, to a matched superposition starter that has been widely taken up in the case of high pressure lamps.

An inventive circuit with a switch in parallel with the lamp is illustrated in FIG. 7. The electronic switch is, once again, a cost-effective triac. A triac can be switched on at any desired time, but can be switched off only at a current zero. The triac must therefore be switched on at a certain time after a current zero, and so there is a need for a phase gating control. This is a phase chopping seen from the lamp.

In the case of the phase drive circuit, a capacitor C2 is charged via a resistor RTeil. At a certain voltage, the diac X5 switches on the triac X4. The value of the resistor RTeil is selected such that the desired output is set. However, a symmetrical lamp current does not result, which means that the time differences from the zero crossing to the starting of the triac in the positive half wave are not the same as in the negative half wave. Consequently, the circuit is augmented in order thus to arrive at a phase control circuit without hysteresis. The basic circuit composed of RTeil and C2 is supplemented in the process by the network composed of the resistors R3, R4 and the diodes D1, D2, D3, D4. This leads to a symmetrical lamp current.

In the case of this inventive circuit arrangement, the power consumption of the overall system is much less distorted than in the case of a circuit arrangement according to the prior art. This may be illustrated using the examples of the 65 W high pressure sodium vapor lamp from FIGS. 4 and 6:

TABLE 2
Parameters of a high pressure sodium vapor lamp for various
circuits, U_{N} = 220 V, f = 50 H_{z}

| | Arrangement switch | | |
|---|---|---|---|
| | | In series with | In parallel with |
| | Without | the lamp | the lamp |
| | Inductor | | |
| | Adapted approx | | |
| | 60 W NAV | 125 W HQL | 125 W HQL |
| Interpulse | | 1.4 | 3.25 |
| pause [ms] | | | |
| Z_{D} [Ω] | 202 | 143 | 143 |
| L_{D} [mH] | 643 | 457 | 457 |
| R_{D} [Ω] | 15.4 | 12.7 | 12.7 |
| U_{L} [V] | 86 | 88 | 89 |
| P_{S} [W] | 79.6 | 76.7 | 80.7 |
| P_{L} [W] | 67 | 65.6 | 65.4 |
| I_{N} [A] | 0.879 | 0.907 | 1.07 |
| Uₚₖ [V] | 135 | 165 | 176 |
| 0.3 λ [%] | 12.4 | 11.6 | 10.3 |
| I₃/I₁ [%] | 5.2 | 13.1 | 4.0 |
| I₅/I₁ [%] | 1.4 | 4.9 | 3.0 |
| I₇/I₁ [%] | 0.4 | 3.3 | 1.3 |
| I₉/I₁ [%] | 0.2 | 2.3 | 0.4 |

The known dimmer circuit according to FIG. 5 is treated below.

FIG. 4 shows the lamp voltage U_{L} and the lamp current I_{L} in the case of a phase gating controller with a switch in series with the lamp, and table 2 shows the associated time averaged variables. In the case of the phase gating controller, the voltage U_{L} is switched on with a delay of 1.4 ms after the current zero. Because of the inter pulse pause of 1.4 ms, the arc cools down more than in the case of continuous operation, the restarting peak Uₚₖ being increased thereby. However, it can be seen that the restarting peaks are still very much lower than the line voltage U_{N}. The lamp current I_{L} is equal to the input current I_{N}.

The permitted proportion of the current in the third harmonic is 0.3λ=11.6%, while the real value with I₃/I₁=13.1% is clearly above the limiting value. The current proportion of the 5th harmonic almost reaches the limiting value, and the current proportion in the 7th harmonic is equal to the limiting value. Consequently, a high pressure sodium vapor lamp dimmed with a dimmer circuit according to the prior art will not satisfy the IEC 1000-3-2 standard.

The inventive circuit according to FIG. 7 will now be examined.

It can be seen in FIG. 6 that the lamp voltage U_{L} and the lamp current I_{L} collapse before the end of the half wave. The inter pulse pause is 3.25 ms here. In the half wave following this, an increased restarting voltage of Uₚₖ=176 V is seen that is comparable to the value in the case of the circuit with the switch in series with the lamp. At the instant of the short circuiting of the triac, the input current I_{N} changes only slightly such that the input current is scarcely additionally distorted. The value of I3/I1=4.0% (table 2) is clearly below the permitted limiting value of 10.3%. The proportion of the current of the higher homonics (table 2) is clearly below the limiting values (table 1). Consequently, a high pressure sodium vapor lamp that is implemented with a switch connected in parallel with the lamp can fulfill the IEC 1000-3-2 standard.

The system power consumption of the circuit, operated with a switch in parallel with the 65 W high pressure sodium vapor lamp, with the inductor of the 125 W high pressure mercury vapor lamp is Pₛ=80.7 W, which means a power saving of 43% as against the operation employing a 125 W high pressure mercury vapor lamp with the inductor of the 125 W high pressure mercury vapor lamp (Pₛ=140 W), in conjunction with the same light flux.

Thus, such a circuit can be used to replace a lamp of lower efficiency with a similar dimmed lamp of higher efficiency. The ballast designed for the lamp of low efficiency can hereby be retained. Consequently, a direct replacement can be made for older lamp types of lesser efficiency, which saves much more current than does the original.

The inventive circuit arrangement is integrated in the lamp and, preferably, directly in the lamp base, such that, apart from changing the lamp, no further work arises for the purpose of replacing the older lamp type with a more efficient lamp. It can be advantageous in this case when a temperature measurement is provided in the circuit arrangement. This can measure the temperature at a predetermined point T_{c} on the wall of the base, and can dim the lamp more strongly in order to protect the lamp and the circuit arrangement in the event of excessive temperature, in order to limit the output of heat by the lamp. Furthermore, it is possible to provide a temperature switch-off which switches off the circuit arrangement in the event of the latter experiencing excessive temperature persistently.

It is also possible to integrate, in such a lamp with dimmer, an interface that permits further dimming stages to be implemented, for example for night-time lowering. Various ways of transmitting signals are conceivable in this case, for example an additional control connection, electromagnetic transmission or the like. The interface can also have an input for so-called ripple-control signals that set the various dimming stages. These signals are modulated onto the normal current line and can be extracted by means of suitable filters.

1. A circuit arrangement for adapting the output of a high pressure discharge lamp that is suitable for operating with an inductor, the circuit arrangement comprising:
an electronic switch that is connected in parallel with the high pressure discharge lamp, wherein the parallel circuit is arranged in series with the inductor, wherein the circuit arrangement is arranged in the high pressure discharge lamp.

2. The circuit arrangement as claimed in claim 1, wherein the circuit arrangement is arranged in a base of the high pressure discharge lamp.

3. The circuit arrangement as claimed in claim 1, wherein the electronic switch is a triac.

4. The circuit arrangement as claimed in claim 1, wherein in that the electronic switch is a thyristor.

5. The circuit arrangement as claimed in claim 1, wherein the electronic switch is a transistor.

6. The circuit arrangement as claimed in claim 1, further comprising:
a drive circuit for the electronic switch, wherein the drive circuit for the electronic switch is configured such that it provides a lamp current such that the lamp current is a pure alternating current without a DC component.

7. The circuit arrangement as claimed in claim 1, further comprising:
a drive circuit for the electronic switch, wherein the drive circuit for the electronic switch is tuned such that the circuit arrangement outputs a predetermined power to the high pressure discharge lamp.

8. The circuit arrangement as claimed in claim 1, further comprising:
a drive circuit for the electronic switch, wherein the drive circuit comprises an input via which the output power of the circuit arrangement to the lamp can be set.

9. The circuit arrangement as claimed in claim 8, wherein the input is configured to receive a line-transmitted signal being fed into the input.

10. The circuit arrangement as claimed in claim 8, wherein in that the input comprises a receiver for electromagnetic radiation, and wherein the drive circuit for the electronic switch is further configured such that the output power is controlled via an electromagnetic radio signal.

11. The circuit arrangement as claimed in claim 1, wherein in that the circuit arrangement further comprises a temperature measuring element that is fitted at a predetermined site on a base housing of the high pressure discharge lamp.

12. The circuit arrangement as claimed in claim 11, wherein the circuit arrangement is further configured to reduce the power output to the high pressure discharge lamp above a predetermined temperature of the temperature measuring element.

13. The circuit arrangement as claimed in claim 11, wherein the circuit arrangement is further configured to switch off the high pressure discharge lamp in the event of a permanently increased temperature above the predetermined temperature.

14. A method for operating efficient high pressure discharge lamps as a replacement for less efficient high pressure discharge lamps, wherein in that the efficient high pressure discharge lamp is operated with an output that entails a light flux which corresponds substantially to the light flux of the less efficient high pressure discharge lamp that is to be replaced.

15. The method as claimed in claim 14, wherein the output setting is performed by periodic short circuiting the high pressure discharge lamp such that the arc is prematurely extinguished.

16. The method as claimed in claim 15, wherein the periodic short circuiting of the high pressure discharge lamp is synchronized with the line frequency.

17. A high pressure discharge arrangement, comprising;
an inductor;
a circuit arrangement for adapting the output of the high pressure discharge lamp that is suitable for operating with the inductor, the circuit arrangement comprising an electronic switch wherein, the connected in parallel with the high pressure discharge lamp, and this parallel circuit is connected in series with the inductor, wherein the circuit arrangement is arranged in the high pressure discharge lamp.
